(19) United States
(12) Patent Application Publication
(10) Pub. No.: US 2012/0117808 A1
(43) Pub. Date: May 17, 2012

(54) UTENSIL HAVING AN INTEGRATED HEAT TRANSFER RESERVOIR

(75) Inventor: M. Troy Smalley, Kaysville, UT (US)

(73) Assignee: SUNDIAL TECHNOLOGIES, LLC, Kaysville, UT (US)

(21) Appl. No.: 13/294,357

(22) Filed: Nov. 11, 2011

Related U.S. Application Data
(60) Provisional application No. 61/412,670, filed on Nov. 11, 2010.

(51) Int. Cl. A47J 43/28; B29C 65/08; B32B 37/24

(52) U.S. Cl. 30/324; 156/242; 156/73.1

(57) ABSTRACT

The present disclosure is directed to embodiments of a utensil, such as a spoon, having an integrated heat transfer reservoir that can facilitate transfer of heat from or to an external environment, such as a liquid (e.g., soup, hot cocoa), to cool or warm the temperature of that external environment. The utensil can include a handle and a head. The head can be coupled to the handle. The head comprises a heat transfer reservoir. A top piece of the head and a bottom piece of the head can be configured to mate together to define a void within the head. The void has a volume and at least a portion of the volume of the void can be filled with a heat transfer material configured to absorb and store heat.

### RELATED APPLICATIONS

This application claims the benefit under 35 U.S.C. § 119(e) of U.S. Provisional Patent Application No. 61/412,670, filed Nov. 11, 2010, and titled “UTENSIL HAVING AN INTEGRATED HEAT TRANSFER RESERVOIR,” which is hereby incorporated by reference herein in its entirety.

### TECHNICAL FIELD

The present disclosure relates generally to eating and cooking utensils.

### SUMMARY

The present disclosure is directed to embodiments of a utensil having an integrated heat transfer reservoir.

Additional aspects and advantages will be apparent from the following detailed description of preferred embodiments, which proceeds with reference to the accompanying drawings.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 illustrates a side view of a utensil having an integrated heat transfer reservoir, according to one embodiment of the present disclosure.

FIG. 2 illustrates a perspective top view of the utensil of FIG. 1.

FIG. 3 illustrates a perspective bottom view of the utensil of FIG. 1.

FIG. 4 illustrates an end view of the utensil of FIG. 1.

FIG. 5 illustrates a top view of the utensil of FIG. 1.

FIG. 6 illustrates a bottom view of the utensil of FIG. 1.

FIG. 7 illustrates an exploded side view of the utensil of FIG. 1,

FIG. 8 illustrates an exploded bottom perspective view of the utensil of FIG. 1.

FIG. 9 illustrates an exploded top perspective view of the top piece and the bottom piece of the utensil of FIG. 1.

FIG. 10 illustrates an exploded end view of the utensil of FIG. 1.

FIG. 11 illustrates an exploded view of the utensil of FIG. 1.

### DETAILED DESCRIPTION OF PREFERRED EMBODIMENTS

Embodiments may be best understood by reference to the drawings, wherein like parts are designated by like numerals throughout. It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure, but is merely representative of possible embodiments of the disclosure. In addition, the steps of a method do not necessarily need to be executed in any specific order, or even sequentially, nor need the steps be executed only once, unless otherwise specified. In some cases, well-known structures, materials, or operations are not shown or described in detail.

The present disclosure is directed to a utensil, such as a spoon, having an integrated heat transfer reservoir configured to absorb or release heat to effect a thermodynamic change in an external environment.

The present disclosure is also directed to a method of manufacturing a utensil having an integrated heat transfer reservoir.

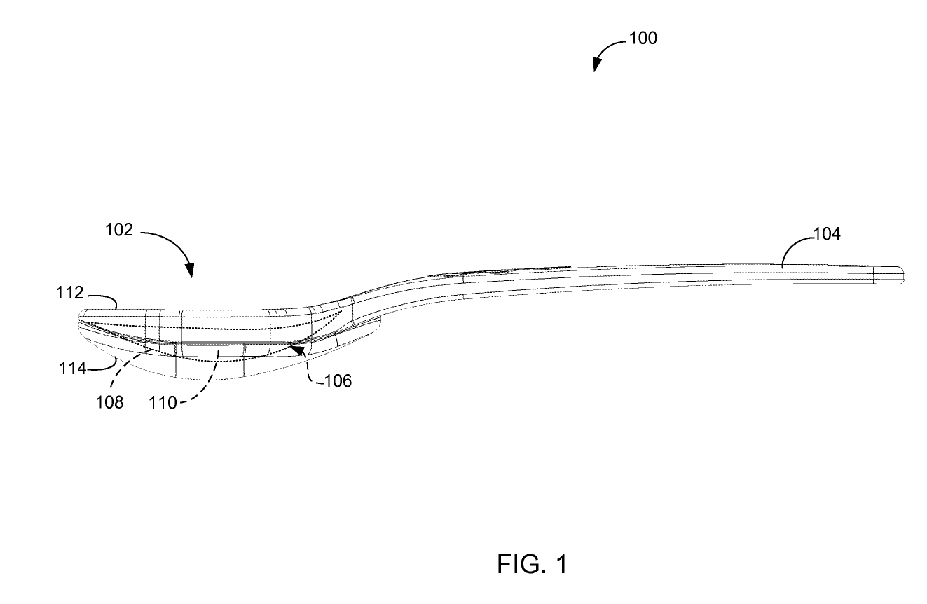

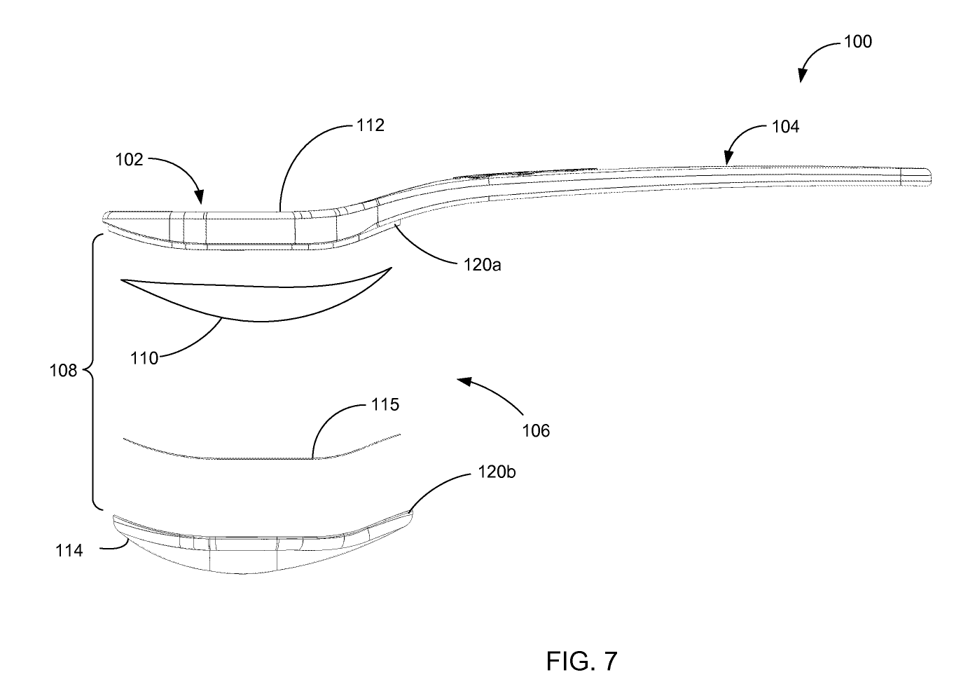

FIGS. 1-6 illustrate views of one embodiment of a utensil 100 having an integrated heat transfer reservoir 106. FIGS. 7-11 are exploded views of the utensil 100. In the illustrated embodiment, the utensil 100 is an eating utensil, and more specifically is a spoon. As can be appreciated, other embodiments may comprise other utensils, including but not limited to a knife, a fork, a ladle, a scoop, a spatula, and the like.

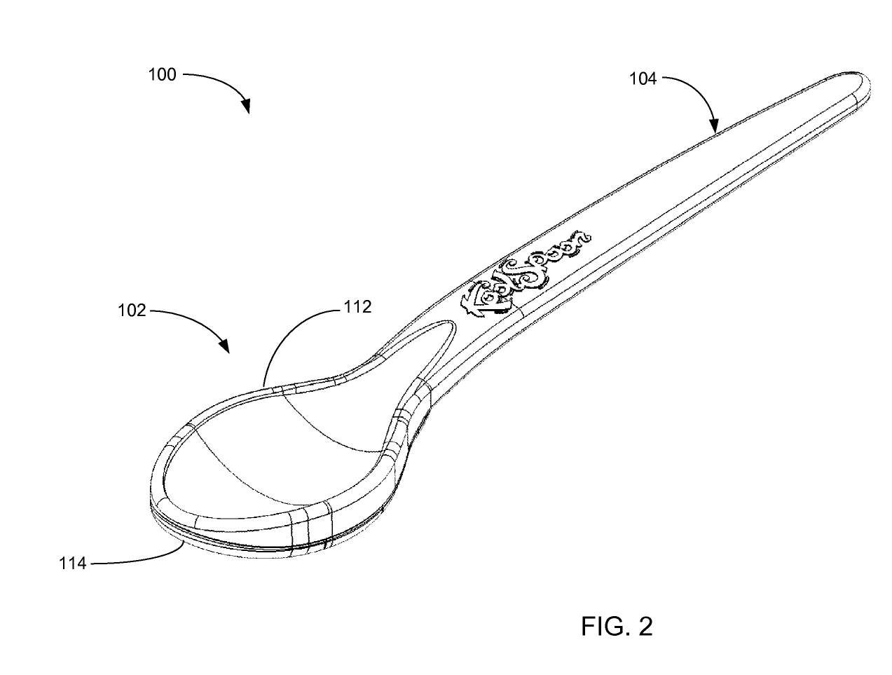

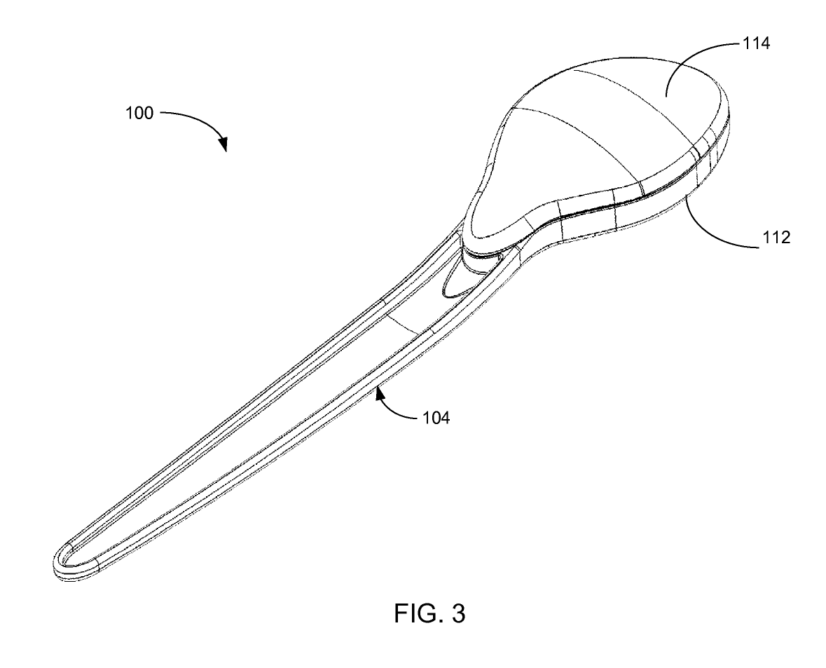

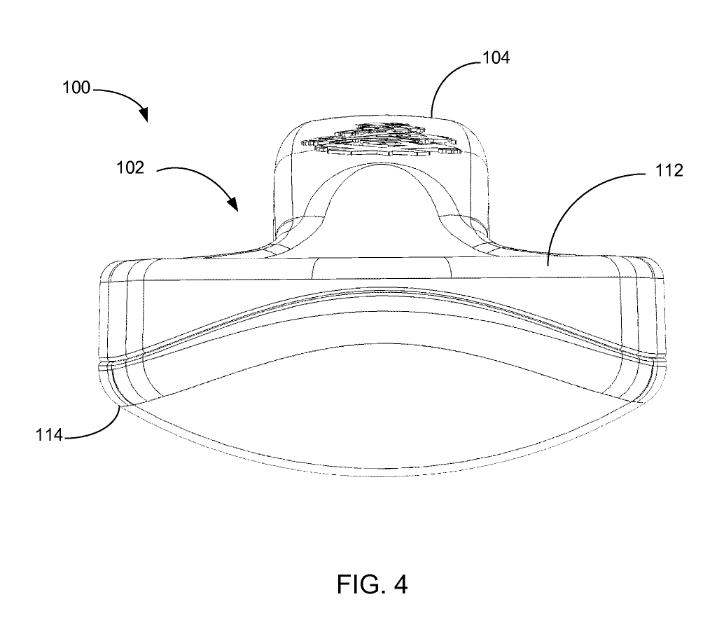

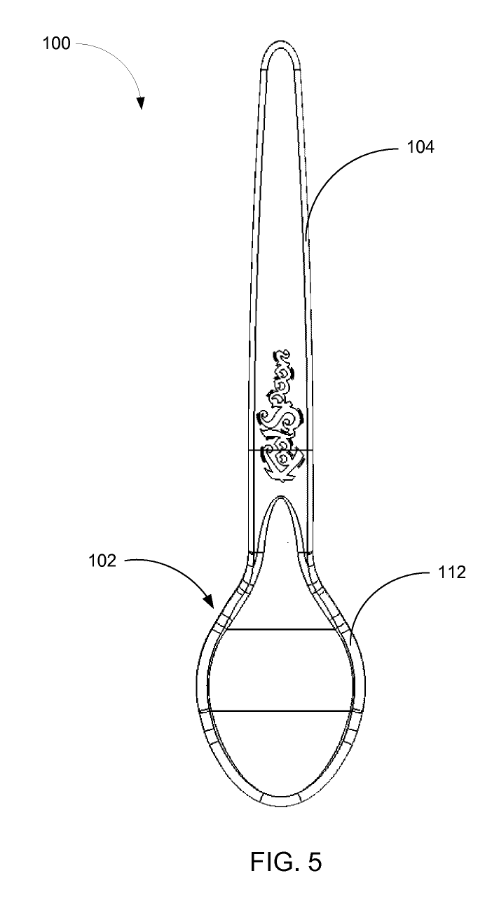

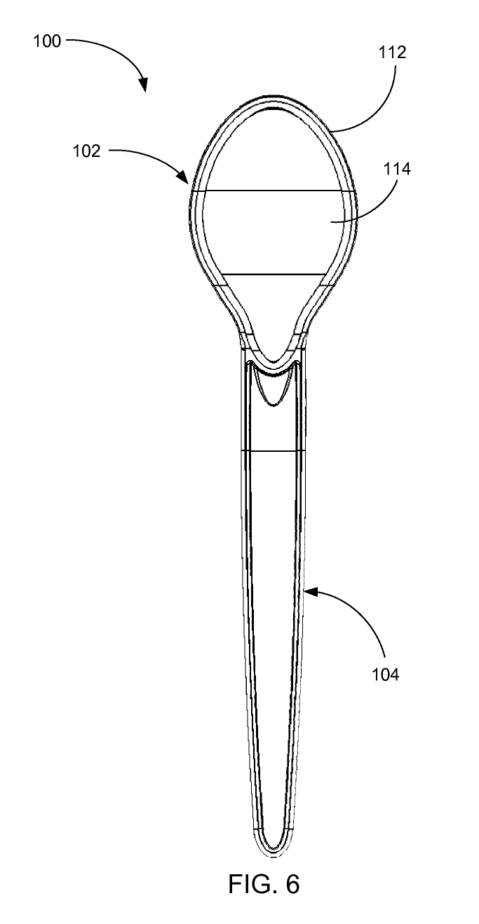

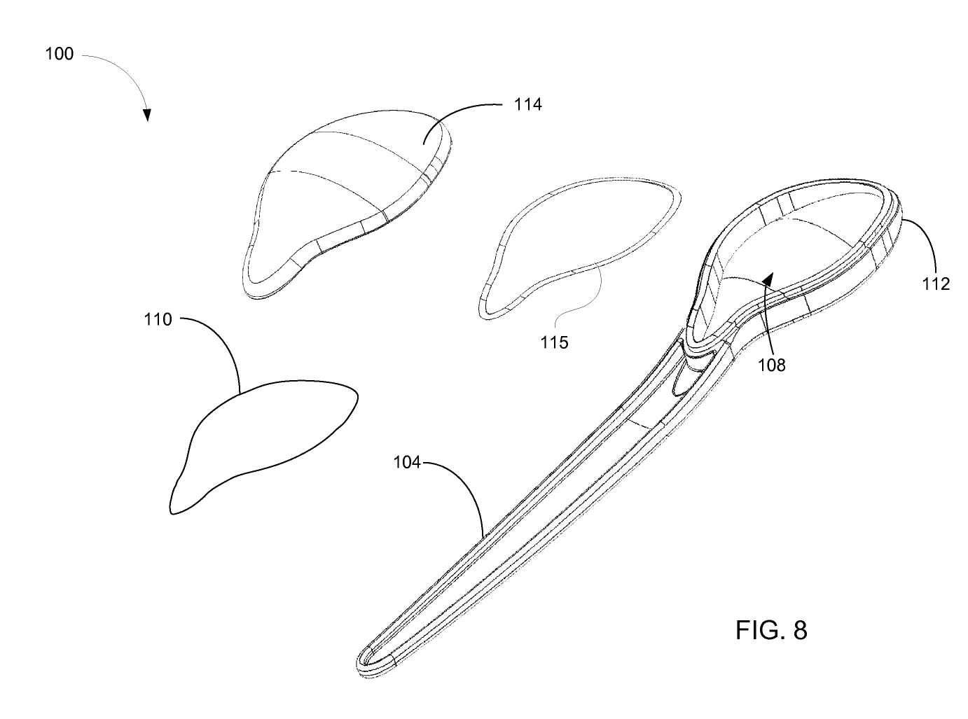

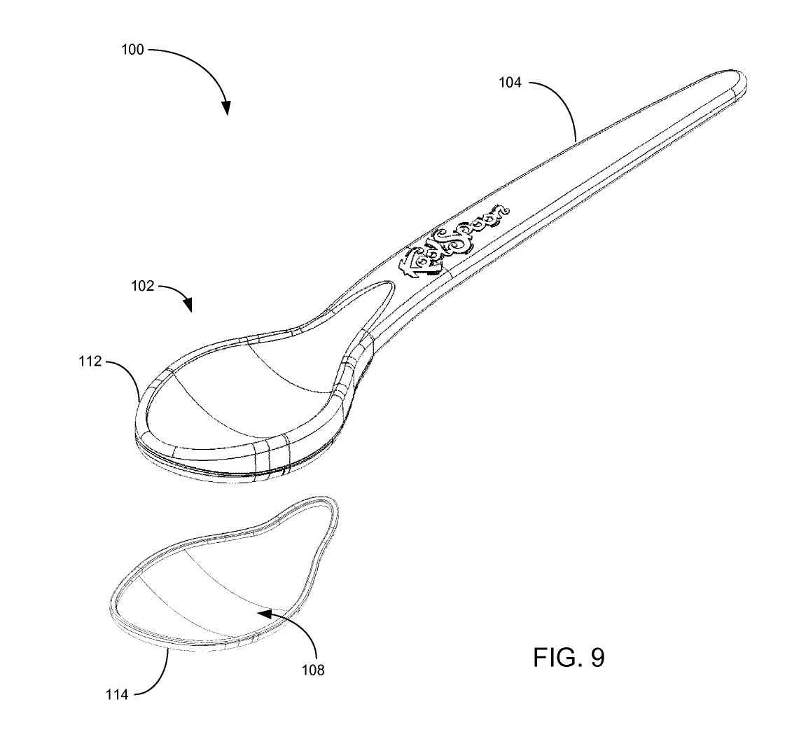

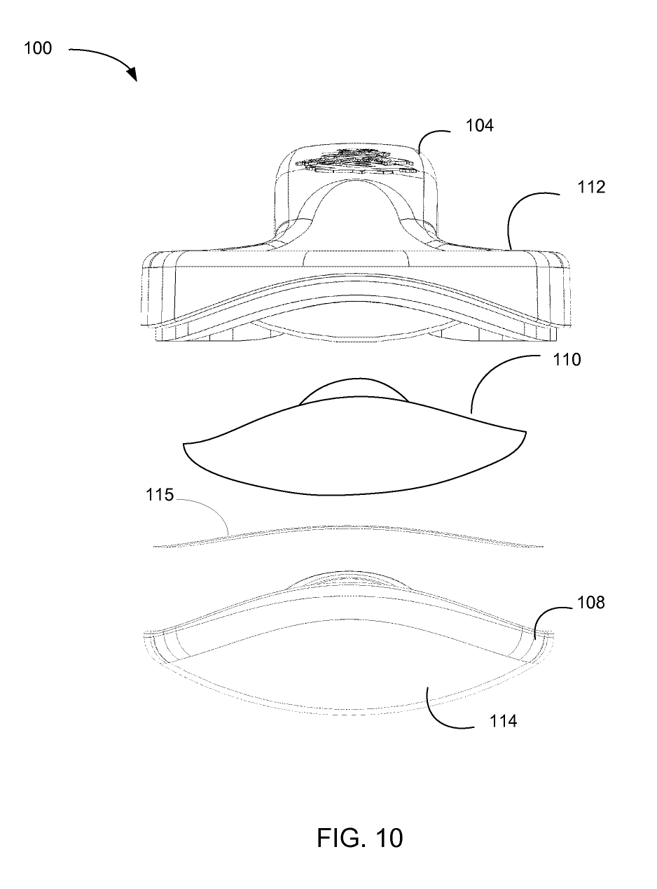

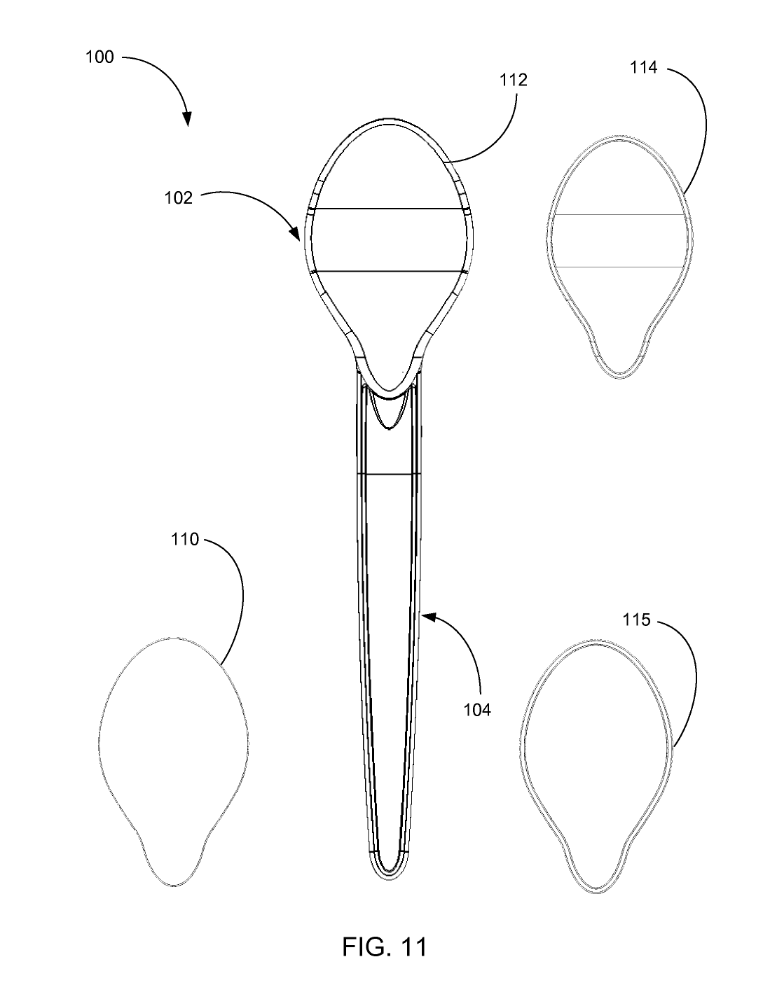

FIG. 1 illustrates a side view of the utensil and shows the integrated heat transfer reservoir 106 in a hidden, dashed line. FIG. 2 illustrates a perspective top view and FIG. 3 illustrates a perspective bottom view of the utensil 100. FIG. 4 is an end view of the utensil 100. FIG. 5 is a top view and FIG. 6 is a bottom view of the utensil 100. FIG. 7 is an exploded side view of the utensil 100, FIGS. 8-11 illustrate various exploded views of a top piece 112 and bottom piece 114 of the utensil 100. Specifically, FIG. 8 illustrates an exploded bottom perspective view, FIG. 9 illustrates an exploded top perspective view, FIG. 10 is an exploded end view, and FIG. 11 is an exploded view of the top piece 112 and the bottom piece 114 of the utensil.

Referring collectively to FIGS. 1-11, the utensil 100 may comprise a head 102 and a handle 104. The handle 104 may be an elongate shaft configured to be grasped in a hand of a user and configured to support the head 102. The elongate shaft may taper toward the head 102. The head 102 may be sized and configured to fit into a mouth of a user. The head 102 may be configured to transport food from one position to another, such as, for example, from a plate of a user to the mouth of a user. In the illustrated embodiment, the head 102 of the spoon utensil 100 may comprise a shallow concave upper surface having an elliptical shape. The head 102 is coupled to the handle 104.

The head 102 includes a heat transfer reservoir 106. The heat transfer reservoir 106 may comprise a void 108 (or other container-like structure) within the structure of the head 102. The void 108 may be at least partially filled with a heat transfer material 110 having appropriate thermodynamic properties to absorb and store heat for a period of time. In particular, in the illustrated embodiment, the concave head 102 of the spoon 100 is hollow, defining the void 108. The head 102 may comprise a top piece 112 and a bottom piece 114 shaped and configured to define the void 108. A sealing member 115 (see e.g., FIG. 7), such as a gasket or O-ring, may be disposed within the void 108, between the top piece 112 and the bottom piece 114, to seal the void 108 relative to an external environment. The top piece 112 may form a top half of the spoon head 102 and may couple to the handle 104. The bottom piece 114 may form the bottom half of the spoon head 102. The top piece 112 and bottom piece 114 may be shaped to couple together around a perimeter of the head 102 at an outer edge, while leaving a space between the top piece 112 and bottom piece 114 in the middle of the head 102, thereby defining the void 108.

The void 108 of the head may be at least partially filled with, or otherwise contain, a heat transfer material 110 to absorb and store heat. In the illustrated embodiment, the heat transfer material 110 may be, for example, a super-absorbent polymer gel, such as LiquiBlock™ 44-OC. In other embodiments, liquid or even solid materials may be used. The heat transfer material 110 can be cooled, or even frozen, and then the head of the spoon can be used, for example, to cool a hot liquid or other substance, such as soup, hot cocoa, and the like, or to otherwise maintain the temperature of a cold substance. Heat is transferred from the external environment, namely the hot liquid or other substance, and into the heat transfer material 110 of the heat transfer reservoir 106. Similarly, the heat transfer material 110 can be heated, and then the head 102 of the spoon can be used, for example to heat a cold substance, such as ice cream, or maintain the temperature of a heated substance.

The void 108 of the head may be filled with heat transfer material 110 to a level that leaves room to allow for expansion of the heat transfer material 110. For example, the heat transfer material 110 may expand when it is frozen. The additional space may aid in avoiding expansion of the heat transfer material 110 beyond the volume of the void 108 and causing the head 102 of the spoon 100 to undesirably expand or even burst. In other embodiments, a flexible material may be used to form one or more surfaces of the void such that expansion may be accommodated even if heat transfer material fills the void entirely, or substantially entirely.

The expansion volume of a heat transfer material 110, such as LiquiBlock™ 44-OC, typically may be about 7-9% of the unfrozen gel volume. As can be appreciated, the expansion volume of the heat transfer material 110 may depend on the type and composition.

In the illustrated embodiment, a typical volume of heat transfer material 110 may be about two teaspoons (about 10 ml). This amount of heat transfer material 110, when frozen, may cool about one cup of liquid, such as water, approximately 15-30° F., depending on the type of heat transfer material 110 used, the material of the cup, the heating method of the cup of liquid, the type of liquid, the starting temperature of the liquid, the temperature of the surroundings, and the material of the top piece 112 and bottom piece 114.

The top piece 112 and bottom piece 114 may be formed of a plastic having an appropriate ability to transfer heat and having an ability to remain durable and/or rigid when hot and/or when cold. In particular, the top piece 112 and bottom piece 114 may be formed of a material configured to transfer heat between an environment external to the utensil and the heat transfer material within the void of the heat transfer reservoir. Candidate plastics include, but are not limited to, ploycarbonate, polypropylene (PP), and high density polyethylene (HDPE). In another embodiment, the top piece 112 and bottom piece 114 may be made of an appropriate metal to increase the rate of heat transfer between the heat transfer material 110 and the surroundings and to reduce the overall size of the utensil.

The sealing member 115 may be configured to seal the void relative to an external environment. For example, the gasket may restrict or even prevent a foreign substance from leaking into the void 108, for example through the joint where the top piece 112 and the bottom piece 114 join. The sealing member 115 may be positioned on a perimeter of the void 108 and adjacent to or in abutment with the inner wall of the void 108 to seal the joint. Stated differently, the sealing member 115 may be disposed on a periphery of the void 108 and adjacent to or in abutment with the inner wall of the void 108 along the joint between the top piece 112 and bottom piece 114. The sealing member 115 may also be disposed around the heat transfer material 110. In some embodiments, multiple sealing members may be used. In other embodiments, the sealing member itself may comprise a sealed pocket such that it completely surrounds the void.

As can be appreciated, a variety of manufacturing techniques may be possible to produce the desired hollow head of the utensil. According to one embodiment, the method of manufacturing may comprise injection molding of two separate pieces, such as a top piece 112 including a top portion of the utensil head and coupled to the handle and a bottom piece 114 that forms the bottom portion of the utensil head. Then, a heat transfer material, such as a gel, may be deposited in the bottom piece 114 of the utensil. The two parts, the top piece and the bottom piece, can then be sealed together using , for example, ultrasonic welding. Mechanical joints incorporating interference fits and mechanical features 120a, 120b (see, e.g., FIG. 7) that hold the pieces together may also be used. In the event that the joining techniques alone do not provide a desired seal between the top piece 112 and bottom piece 114, one or more sealing members 115 may be inserted during assembly to allow the void 108 to be hermetically sealed.

In another embodiment, an indicating system such as, for example, an electronic indicating system, may be included and may be used to notify a user of when a heat transfer process involving the heat transfer reservoir is complete. For example, a simple set of contact wires mounted inside the heat transfer material 110 could complete a circuit between a small battery and a light source when the heat transfer material changes from a solid (non-conductive) phase to a liquid (conductive) phase. Alternatively, thermocouple devices on the utensil could sense the temperature of the surroundings, the heat transfer material 110, or both (for comparison) and send the data to a display, such as an LCD. In still another embodiment, an outer surface may change color as the heat transfer process occurs.

It will be obvious to those having skill in the art that many changes may be made to the details of the above-described embodiments without departing from the underlying principles of the invention.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. The upper and lower limits of these smaller ranges, which may independently be included in the smaller ranges, is also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the disclosure, the preferred methods and materials are now described.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

What is claimed is:

1. A utensil comprising:
a handle; and
a head coupled to the handle, the head comprising a heat transfer reservoir, the head further comprising a top piece and a bottom piece configured to mate together to define a void of the heat transfer reservoir, wherein the void of the heat transfer reservoir has a volume and at least a portion of the volume of the void is filled with a heat transfer material configured to absorb and store heat.

2. The utensil of claim 1, further comprising:
a sealing member disposed within the void between the top piece and the bottom piece of the head, the sealing member configured to seal a joint where the top piece and the bottom piece adjoin, wherein the joint is sealed relative to an environment external to the void of the utensil.

3. The utensil of claim 1, wherein the utensil comprises a spoon, and wherein the head comprises a shallow concave upper surface having an elliptical shape.

4. The utensil of claim 1, wherein the heat transfer material is a super-absorbent polymer gel.

5. The utensil of claim 1, wherein the heat transfer material is a solid material.

6. The utensil of claim 1, wherein the head of the utensil is formed of a material configured to transfer heat between an environment external to the utensil and the heat transfer material within the void of the heat transfer reservoir.

7. The utensil of claim 5, wherein the head is formed of plastic.

8. The utensil of claim 5, wherein the head is formed of metal.

9. The utensil of claim 1, wherein the top piece and the bottom piece include mechanical joints incorporating interference fits and mechanical features that couple together to secure the top piece and the bottom piece together.

10. A method of manufacturing a utensil having an integrated heat transfer reservoir, the method comprising:
injection molding a top piece of the utensil, the top piece of the utensil including a handle of the utensil;
injection molding a bottom piece of the utensil, the bottom piece configured to couple to the top piece and define a head of the utensil and a void within the head of the utensil;
depositing a heat transfer material in one of the bottom piece of the utensil and the top piece of the utensil, the heat transfer material configured to absorb and store heat; and
sealing together the top piece and the bottom piece.

11. The method of claim 10, wherein the step of sealing together the top piece and the bottom piece comprises using ultrasonic welding.

12. The method of claim 10, wherein the top piece and the bottom piece include mechanical joints incorporating interference fits and mechanical features that couple together to secure the top piece and the bottom piece together.

13. The method of claim 10, wherein the step of depositing a heat transfer material comprises depositing a super-absorbent polymer gel.

14. The method of claim 10, further comprising depositing a sealing member between the top piece and the bottom piece, the sealing member disposed on a periphery of the void adjacent to an inner wall of the void along a joint between the top piece and bottom piece to seal the void relative to an external environment.
